(19) United States
(12) Patent Application Publication
(10) Pub. No.: US 2026/0269274 A1
(43) Pub. Date: Sep. 10, 2026

(54) ELECTRODE ASSEMBLY AND SECONDARY BATTERY HAVING THE ELECTRODE ASSEMBLY

(71) Applicant: SAMSUNG SDI CO., LTD., Yongin-si (KR)

(72) Inventors: Dong Bok YANG, Yongin-si (KR); Cheon Soo KIM, Yongin-si (KR); Tae Su JEONG, Yongin-si (KR); Eun Hyeok SHIN, Yongin-si (KR); Jung Ah YOON, Yongin-si (KR)

(21) Appl. No.: 19/280,501

(22) Filed: Jul. 25, 2025

(30) Foreign Application Priority Data
Mar. 4, 2025 (KR) 10-2025-0027236

(51) Int. Cl. H01M 4/66; B60L 50/64; H01M 4/13; H01M 4/36; H01M 4/62; H01M 10/052; H01M 50/105

(52) U.S. Cl. CPC H01M 4/667; H01M 4/13; H01M 4/366; H01M 4/625; H01M 4/628; H01M 4/668; H01M 10/052; H01M 50/105; B60L 50/64; H01M 2220/20

(57) ABSTRACT

An electrode assembly including a first electrode plate, a separator, and a second electrode plate, wherein the first electrode plate includes a first insulating layer having a first surface and a second surface, a first substrate configured to cover the first surface and the second surface of the first insulating layer, the first substrate being made of a metal foil, the first substrate having a first electrode tab, the first electrode tab extending and protruding in a first direction from one side of the first substrate, and the first electrode tab also extending in a second direction from the one side, and a first electrode active material layer configured to cover at least one surface of the first substrate, wherein the first electrode tab consists of an uncoated portion that is not coated with the first electrode active material layer, and a secondary battery including the same.

### CROSS-REFERENCE TO THE RELATED APPLICATION

The present application claims priority to and the benefit of Korean Patent Application No. 10-2025-0027236, filed on Mar. 4, 2025, in the Korean Intellectual Property Office, the entire disclosure of which is incorporated herein by reference.

### BACKGROUND

### 1. Field

Embodiments of the present disclosure relate to an electrode assembly and a secondary battery having the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments of the present disclosure provide for an electrode assembly configured such that an insulating layer is provided in a substrate of an electrode plate, such that the electrode plate is overall thin and light, which improves energy density per unit weight of a secondary battery, and no insulating layer is provided in an electrode tab, such that welding and coupling between a plurality of aligned electrode tabs are easily performed, and a secondary battery including the same.

These and other aspects and features of the present disclosure will be described in or will be apparent from the following description of embodiments of the present disclosure.

An electrode assembly and a secondary battery according to an embodiment of the present disclosure to accomplish the above object include a first electrode plate, a separator, and a second electrode plate, wherein the first electrode plate includes a first insulating layer having a first surface and a second surface, a first substrate configured to cover the first surface and the second surface of the first insulating layer, the first substrate being made of a metal foil, the first substrate having a first electrode tab, the first electrode tab extending and protruding in a first direction from one side of the first substrate, and the first electrode tab also extending in a second direction from the one side of the first substrate, and a first electrode active material layer configured to cover at least one surface of the first substrate, wherein the first electrode tab consists of an uncoated portion that is not coated with the first electrode active material layer.

The first electrode tab and the first insulating layer may not overlap each other on a plane.

The first substrate may include a first x substrate having a receiving recess configured to allow the first insulating layer to be received therein and a first y substrate configured to cover the first x substrate and the first insulating layer after the first insulating layer is received in the receiving recess.

The width of the receiving recess may be equal to the width of the first insulating layer, and the length of the receiving recess may be equal to the length of the first insulating layer.

The first electrode active material layer may overlap the first insulating layer on a plane.

The first substrate and the first insulating layer may have the same length in the second direction.

The length of the first substrate in the first direction, excluding the first electrode tab, may be equal to or greater than the length of the first insulating layer in the first direction.

The first electrode plate may include the other side, wherein the other side is a side opposite the one side, and the first substrate and the first electrode active material layer may be exposed on each of the one side and the other side.

The first electrode plate may further include the other side, wherein the other side is a side opposite the one side, and the first substrate, the first electrode active material layer, and the first insulating layer may be exposed on each of the one side and the other side.

The first insulating layer may include at least one of polyimide (PI), polyethylene terephthalate (PET), polypropylene (PP), polyethylene (PE), polystyrene (PS), acrylonitrile butadiene styrene (ABS), polyoxymethylene (POM), polyvinyl chloride (PVC), polycarbonate (PC), polycaprolactone (PCL), polylactic acid (PLA), acrylic resin, polybutylene terephthalate (PBT), celluloid, polytetrafluoroethylene, Bakelite, epoxy, melamine-formaldehyde, amino, and phenol-formaldehyde.

The electrode assembly and the secondary battery may further include a first conductive layer interposed between the first substrate and the first electrode active material layer.

The first conductive layer may include at least one of carbon nanotubes (CNT), carbon black, Denka black, and Super-P.

The electrode assembly and the secondary battery may further include a first protective layer configured to cover a first region of the first electrode tab adjacent to the first electrode active material layer and a second region of the first electrode active material layer adjacent to the first electrode tab.

The first protective layer may be formed by applying at least one of polyimide (PI) or ceramic or by attaching a polyethylene terephthalate (PET) tape.

The second electrode plate may include a second insulating layer having a third surface and a fourth surface, a second substrate configured to cover both the third surface and the fourth surface of the second insulating layer, the second substrate being made of a metal foil, the second substrate having a second electrode tab, the second electrode tab extending and protruding in the first direction from a first side of the second substrate, the second electrode tab also extending in the second direction from the first side of the second substrate, and a second electrode active material layer configured to cover at least one surface of the second substrate, wherein the second electrode tab may consist only of an uncoated portion that is not coated with the second electrode active material layer.

The first electrode tab and the second electrode tab may overlap each other in a third direction (z), which is a height direction, wherein the first electrode plate and the second electrode plate are stacked in the state in which the separator is interposed therebetween.

The first electrode tab and the second electrode tab may be spaced apart from each other in the second direction such that the first electrode tab and the second electrode tab are electrically separated.

The second electrode tab and the second insulating layer may not overlap each other on a plane.

The electrode assembly and the secondary battery may further include a second conductive layer interposed between the second substrate and the second electrode active material layer.

According to the present disclosure, it is possible to create an electrode assembly configured such that an insulating layer is provided in a substrate of an electrode plate, such that the electrode plate is overall thin and light, which improves energy density per unit weight of a secondary battery, and no insulating layer is present in an electrode tab, such that welding and coupling between a plurality of aligned electrode tabs are easily performed, and a secondary battery including the same.

In another aspect of the present disclosure, a battery pack can be manufactured using a battery having an improved structure, and a vehicle configured to store and use such a battery pack can be created.

However, the technical effects to be achieved in the embodiment of the disclosure are not limited to the technical problems mentioned above, and other technical effects not mentioned herein will be clearly understood from the following description by those skilled in the art to which the disclosure belongs.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view showing an example of a secondary battery according to the present disclosure;

FIG. 2 is an exploded perspective view showing an example of the secondary battery according to the present disclosure;

FIG. 3 is a plan view of an exemplary electrode assembly of the secondary battery shown in FIG. 2;

FIG. 4 is an example of a sectional schematic view of the electrode assembly taken along line 4-4′ of FIG. 3;

FIG. 5 is an example of a sectional schematic view of the electrode assembly taken along line 5-5′ of FIG. 3;

FIG. 6 is an exploded perspective view showing an example of the electrode assembly of FIG. 3 before a first electrode plate is blanked;

FIG. 7 is another example of a sectional schematic view of the electrode assembly taken along line 4-4′ of FIG. 3;

FIG. 8 is another example of a sectional schematic view of the electrode assembly taken along line 5-5′ of FIG. 3;

FIG. 9 is another example of a sectional schematic view of the electrode assembly taken along line 4-4′ of FIG. 3;

FIG. 10 is another example of a sectional schematic view of the electrode assembly taken along line 4-4′ of FIG. 3;

FIG. 11 is another example of a sectional schematic view of the electrode assembly taken along line 5-5′ of FIG. 3;

FIGS. 12A and 12B are perspective views showing an exemplary battery pack including an exemplary secondary battery according to the present disclosure; and

FIGS. 13A and 13B are a perspective view and a side view, respectively, showing a vehicle including an exemplary battery pack according to the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

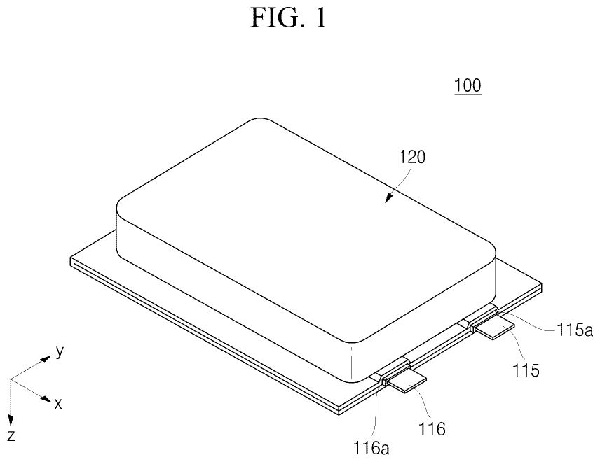

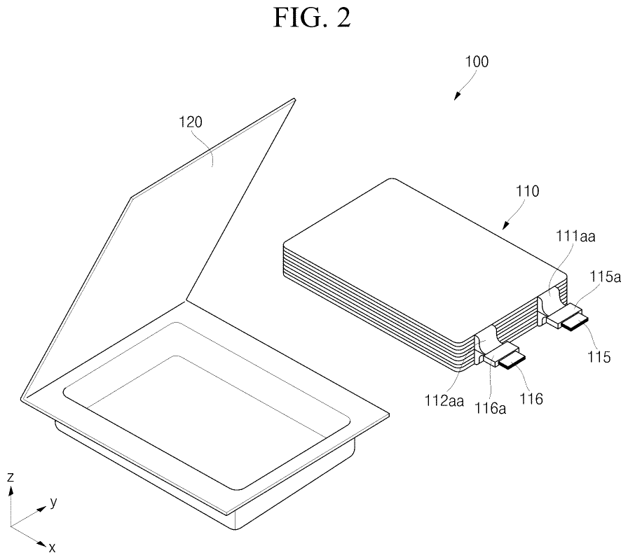

FIG. 1 is a perspective view showing a secondary battery according to the present disclosure, and FIG. 2 is an exploded perspective view showing the secondary battery according to the present disclosure.

As shown in FIGS. 1 and 2, the secondary battery 100 according to the present disclosure may include an electrode assembly 110 and a case 120 in which the electrode assembly 110 is received. The electrode assembly 110 may be received in the case 120 together with an electrolyte (not shown).

The case 120 may include a pouch body and a pouch cover formed by folding a rectangular pouch film in a longitudinal direction (x). The electrode assembly 110 may be received in a receiving portion provided in the pouch body, and the pouch cover may be folded and coupled to the pouch body, such that the case 120 may be sealed.

The case 120 is shown as being pouch-shaped, but the case may be prismatic or cylindrical. If the case 120 is prismatic or cylindrical, the electrode assembly 110 may be received in the case 120 and a cap assembly may be coupled to the case to seal the case. In the present disclosure, the shape of the case 120 is not limited to a pouch.

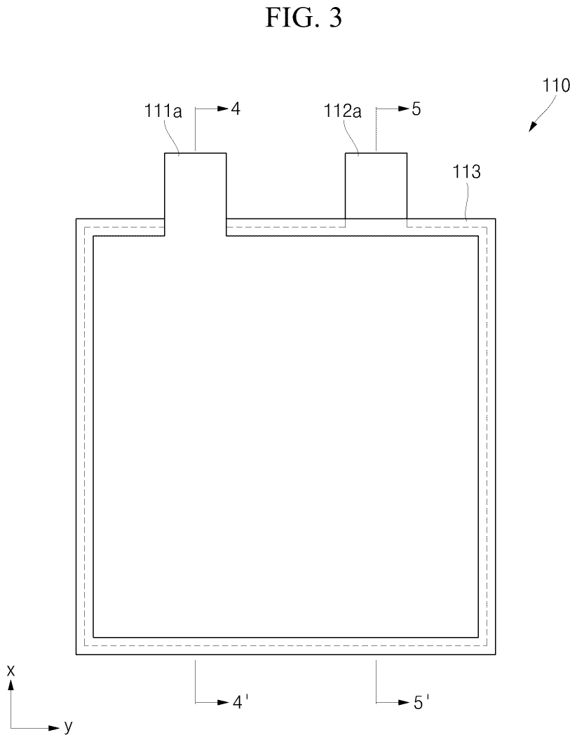

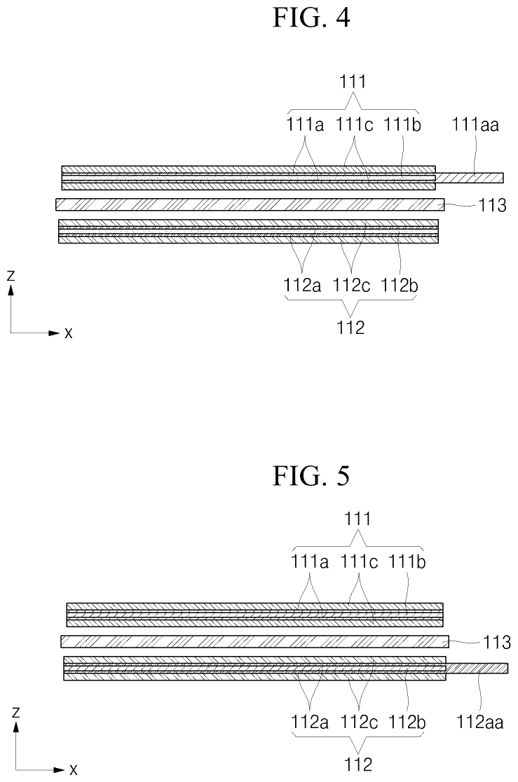

FIG. 3 is a plan view of the electrode assembly of the secondary battery shown in FIG. 2, FIG. 4 is an example of a sectional schematic view of the electrode assembly taken along line 4-4′ of FIG. 3, and FIG. 5 is an example of a sectional schematic view of the electrode assembly taken along line 5-5′ of FIG. 3. In FIGS. 4 and 5, the electrode assembly is shown as including a first electrode plate 111, a separator 113, and a second electrode plate 112 spaced apart from each other. In practice, a plurality of first electrode plates 111, a plurality of separators 113, a plurality of second electrode plates 112, and a plurality of separators 113 may be alternately stacked in contact with each other.

Hereinafter, the electrode assembly according to the present disclosure will be described with reference to FIGS. 2 to 5.

The electrode assembly 110 may be formed by sequentially stacking a first electrode plate 111, a separator 113, a second electrode plate 112, and a separator 113. The first electrode plate 111 may operate as a first electrode, such as a positive electrode, and the second electrode plate 112 may operate as a second electrode, such as a negative electrode. The electrode assembly 110 may include or be referred to as an electrode group, an electrode body, a roll (e.g., a multi-layer pattern), or a jelly-roll (e.g., a spiral or pinwheel pattern, with multiple layers winding out in a continuous and gradually widening curve). As another example, the electrode assembly 110 may be configured such that the first electrode plate 111, the separator 113, the second electrode plate 112, and the separator 113 are stacked and wound into in a jelly-roll form. Hereinafter, an example in which the first electrode plate 111, the separator 113, the second electrode plate 112, and the separator 113 are stacked will be described for convenience of description.

The first electrode plate 111 may include a first electrode active material layer 111c formed by applying a first electrode active material, such as a transition metal oxide, to a first substrate 111a made of a metal foil, such as aluminum. The first electrode active material layer 111c may be formed on one surface or both surfaces of the first substrate 111a. Hereinafter, an example in which the first electrode active material layer 111c is formed on both surfaces of the first substrate 11 will be described. The first substrate 111a may include a first electrode tab 111aa protruding outward from one side thereof in a first direction (x). One side of the first substrate 111a may be a side extending in a second direction (y).

The first electrode plate 111 may further include a first insulating layer 111b provided in the first substrate 111a. The first electrode substrate 111a may be provided to cover both surfaces of the first insulating layer 111b. However, the first insulating layer 111b may not be provided in the first electrode tab 111aa. The first electrode plate 111 may be configured in a roll form, wherein the first electrode active material layer 111c may be formed on the first substrate 111a, which is the metal foil having the first insulating layer 111b embedded therein, and may be divided into individual first electrode plates 111 each having the first electrode tabs 111aa by blanking. “Blanking” refers to the process of cutting or removing specific shapes from a sheet of material, such as a silicon wafer, to create individual devices or components. The second direction (y) may be the direction in which the roll-type first electrode plate 111 extends, and the first direction (x) may be a width direction of the roll-type first electrode plate 111.

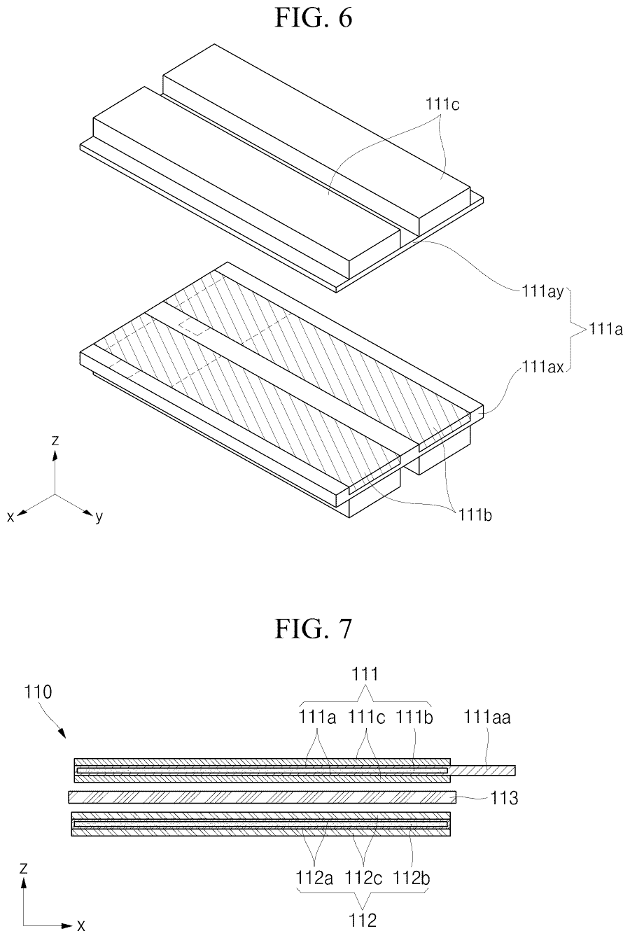

FIG. 6 is an example of a partial exploded view of the first electrode plate 111 before blanking. As shown in FIG. 6, the first substrate 111a may include two metal foils extending in the second direction (y). At least one of the metal foils of the first substrate 111a may be provided therein with a receiving recess configured to allow the first insulating layer 111b to be embedded therein, wherein the receiving recess may extend in the second direction (y). Hereinafter, the first substrate 111a with the receiving recess will be referred to as a first x substrate 111ax, and the first substrate 111a without the receiving recess and having a flat plate shape will be referred to as a first y substrate 111ay.

The first x substrate 111ax may have one or more receiving recesses configured to receive the first insulating layer 111b. However, the receiving recesses of the first x substrate 111ax may extend parallel to each other in the second direction (y) and may be spaced apart from each other in the first direction (x). Although FIG. 6 shows two receiving recesses provided in the first x substrate 111ax, the present disclosure is not limited thereto. The length of the first substrate 111a in the second direction (y) may be equal to the length of the first insulating layer 111b.

After the first insulating layer 111b is received in the recess of the first x substrate 111ax, the first y substrate 111ay may be coupled to the first x substrate 111ax so as to cover the first insulating layer 111b and the first x substrate 111ax. The first insulating layer 111b may be received in the first substrate 111a. The width of the insulating layer 111b in the first direction (x) may be equal to the width of the receiving recess of the first x substrate 111ax in the first direction (x). The first insulating layer 111b may include at least one of polyimide (PI), polyethylene terephthalate (PET), polypropylene (PP), polyethylene (PE), polystyrene (PS), acrylonitrile butadiene styrene (ABS), polyoxymethylene (POM), polyvinyl chloride (PVC), polycarbonate (PC), polycaprolactone (PCL), polylactic acid (PLA), acrylic resin, polybutylene terephthalate (PBT), celluloid, polytetrafluoroethylene, Bakelite, epoxy, melamine-formaldehyde, amino, and phenol-formaldehyde.

The first electrode active material layer 111c may be provided on one surface or both surfaces of the first substrate 111a in which the first insulating layer 111b is received. The first electrode active material layer 111c may be provided on at least one surface of the first substrate 111a so as to overlap the first insulating layer 111b on a plane. The width of the first electrode active material layer 111c in the first direction (x) may be equal to or greater than the width of the first insulating layer 111b in the first direction (x). The length of the first electrode active material layer 111c in the second direction (y) may be equal to the length of the first substrate 111a in the second direction (y) and the length of the first insulating layer 111b in the second direction (y).

The first substrate 111a may be located such that a first electrode uncoated portion, which is not coated with the first electrode active material layer 111c, extends in the second direction (y). The first substrate 111a may be located on one surface of the first electrode active material layer 111c, the first electrode active material layer 111c spaced apart/separated from other coatings of the first electrode active material layer 111c in the first direction (x). The part of the first substrate 111a exposed through the first electrode active material layer 111c may be referred to as the first electrode uncoated portion. The first electrode uncoated portion may not overlap the first insulating layer 111b on a plane. The first electrode active material layer 111c may be provided at the position corresponding to the first insulating layer 111b received in the first substrate 111a. That is, the first electrode active material layer 111c may have the same (or a partial) planar shape matching the first insulating layer 111b, with the first electrode active material layer 111c and the first insulating layer 111b on opposite sides of the first substrate 111a.

The first electrode plate 111 provided with the first electrode active material layer 111c may be divided into individual first electrode plates 111 by blanking. Following the blanking, the first electrode tab 111aa of the first electrode plate 111 may protrude in the first direction (x). The first electrode plate 111 may be smaller than the second electrode plate 112 in the longitudinal direction (x) and the width direction (y) in consideration of the lithium-ion precipitation phenomenon that may occur intermittently on the second electrode plate 112 during charging. The planar size of the second electrode plate 112 may be greater than that of the first electrode plate 111. The first electrode tab 111aa may be a current flow path between the first electrode plate 111 and the outside of the first electrode.

The first insulating layer 111b may be exposed on the other side of the individual first electrode plate 111, which is the opposite side of the individual first electrode plate 111 where the first electrode tab 111aa is located. At this time, the first insulating layer 111b may also be exposed on the side of the individual first electrode plate 111 where the first electrode tab 111aa is located. At this time, the widths of the first electrode active material layer 111c and the first insulating layer 111b of the first electrode plate 111 in the first direction (x) may be equal to each other.

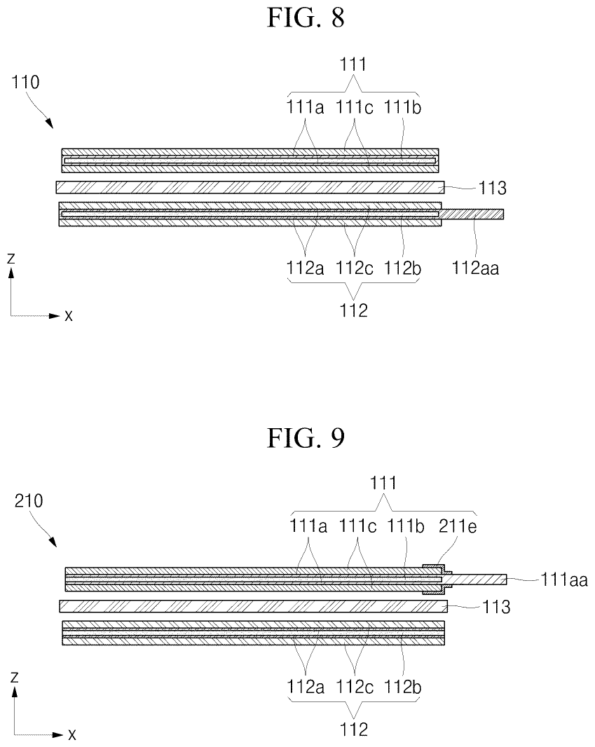

As another example, as shown in FIGS. 7 and 8, if the width of the first insulating layer 111b in the first direction (x) is less than that of the first electrode active material layer 111c, the first insulating layer 111b may not be exposed on one side (and/or the other side) of the first electrode plate 111.

The plurality of first electrode plates 111 having the first electrode tabs 111aa, the plurality of separators 113, the plurality of second electrode plates 112, and the plurality of separators 113 may be sequentially stacked in that order in a third direction (z), which is a height direction. The first electrode tabs 111aa of the plurality of stacked first electrode plates 111 may be aligned at the same position of the electrode assembly 110 in the height direction (z).

The plurality of first electrode tabs 111aa may be electrically connected to a single first electrode lead tab 115 and may extend and protrude outward from the inside of the case 120. The first electrode lead tab 115 may have a flat plate shape that is thicker than the first electrode tab 111aa. An insulating tape 115a may be further interposed between the first electrode lead tab 115 and the case 120. The insulating tape 115a may secure an electrical insulating state between the case 120 and the first electrode lead tab 115.

Because the first insulating layer 111b is located in the first substrate 111a of the first electrode plate 111, the secondary battery 100 may be overall thin and light, thus improving energy density per unit weight of the secondary battery 100. Because the first insulating layer 111b is not provided in the first electrode tab 111aa, welding and coupling between the plurality of aligned first electrode tabs 111aa and the first electrode lead tab 115 may be easily performed.

The second electrode plate 112 may be formed by applying a second electrode active material layer 112c to a second substrate 112a made of a metal foil, such as copper or nickel. The second electrode active material layer 112c may be formed, applied, or otherwise provided on one surface or both surfaces of the second substrate 112a. Hereinafter, an example in which the second electrode active material layer 112c is formed on both surfaces of the second substrate 112a will be described. The second electrode plate 112 may further include a second insulating layer 112b provided in the second substrate 112a. The second electrode substrate 112a may be provided to cover one surface or both surfaces of the second insulating layer 112b. However, the second insulating layer 112b may not be provided in a second electrode tab 112aa. The second electrode plate 112 may be configured in a roll form, wherein the second electrode active material layer 112c may be formed on the second substrate 112a, which is the metal foil having the second insulating layer 112b embedded therein and may be divided into individual second electrode plates 112 each having the second electrode tabs 112aa by blanking. The second substrate 112a may include a second electrode tab 112aa protruding outward from one side thereof in the first direction (x). The second insulating layer 112b included in the second electrode plate 112 may not overlap the second electrode tabs 112aa on a plane, and may be provided at the position corresponding to the second electrode active material layer 112c.

The shape and structure of the second electrode plate 112 may be similar to those of the first electrode plate 111, and a redundant description will be omitted. However, the position where the second electrode tab 112aa of the second electrode plate 112 protrudes and is aligned may be different from the position where the first electrode tab 111aa protrudes and is aligned. The second electrode tab 112aa may be separated from the first electrode tab 111aa in the second direction (y).

Because the second insulating layer 112b is provided on or applied to the second substrate 112a of the second electrode plate 112, the secondary battery 100 may be overall thin and light, such that it improves energy density per unit weight of the secondary battery 100. Because the second insulating layer 112b is not provided in the second electrode tab 112aa, welding and coupling between a plurality of aligned second electrode tabs 112aa and a second electrode lead tab 116 may be easily performed.

The plurality of second electrode tabs 112aa may be electrically connected to a single second electrode lead tab 116, and may extend and protrude outward from the inside of the case 120. The second electrode lead tab 116 may have a flat plate shape that is thicker than the second electrode tab 112aa. An insulating tape 116a may be interposed between the second electrode lead tab 116 and the case 120. The insulating tape 116a may secure an electrical insulating state between the case 120 and the second electrode lead tab 116.

The separator 113 may be located between the first electrode plate 111 and the second electrode plate 112 to prevent electrical short circuit and allow the migration of transition metal ions, and may be made of polyethylene, polypropylene, or a composite film of polyethylene and polypropylene. In the present disclosure, however, the material of the separator 113 is not limited thereto.

The separator 113 may have a larger width and length than the first electrode plate 111 and the second electrode plate 112 in both the first direction (x) and the second direction (y) in order to more reliably prevent short circuit between the first electrode plate 111 and the second electrode plate 112. That is, the planar size of the separator 113 may be greater than that of each of the first electrode plate 111 and the second electrode plate 112.

The separator 113 may be made of any one selected from among polyethylene (PE), polypropylene (PP), and a composite film of the above polyethylene (PE) and polypropylene (PP).

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹ _{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

FIG. 9 is another example of a sectional schematic view of the electrode assembly taken along line 4-4′ of FIG. 3.

The electrode assembly 210 of FIG. 9 may be structurally similar to the electrode assembly 110 shown in FIGS. 4 to 6. However, the electrode assembly 210 may further include a protective layer 211e provided at a first electrode plate 111 so as to cover a part of a first electrode tab 111aa.

The protective layer 211e may be located to cover the region of the first electrode tab 111aa adjacent to one side thereof and the region of a first electrode active material layer 111c adjacent to the first electrode tab 111aa. The protective layer 211e may cover the region of the first electrode tab 111aa adjacent to the first electrode active material layer 111c and the region of the first electrode active material layer 111c adjacent to one side thereof. The protective layer 211e may be formed by applying polyimide (PI) or ceramic or by attaching a polyethylene terephthalate (PET) tape. The protective layer 211e may be made of polyimide (PI), ceramic, polyethylene terephthalate (PET), or an equivalent material thereto. The protective layer 211e may increase thermal safety and mechanical strength, and may reduce defects caused by lithium precipitation from second electrode plates 112 overlapping in the height direction (z).

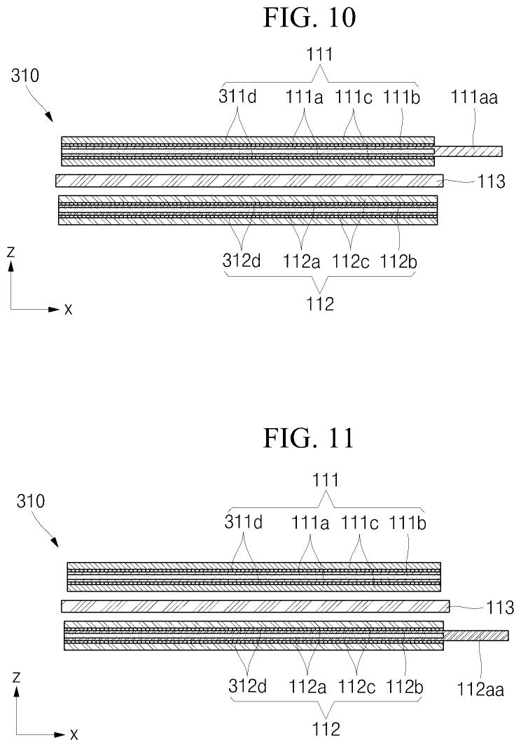

FIG. 10 is another example of a sectional schematic view of the electrode assembly taken along line 4-4′ of FIG. 3, and FIG. 11 is another example of a sectional schematic view of the electrode assembly taken along line 5-5′ of FIG. 3.

The electrode assembly 310 shown in FIGS. 10 and 11 may be structurally similar to the electrode assembly 110 shown in FIGS. 4 to 6. However, the electrode assembly 310 may further include a first conductive layer 311d interposed between a first substrate 111a and a first electrode active material layer 111c and a second conductive layer 312d interposed between a second substrate 112a and a second electrode active material layer 112c.

The size of the first conductive layer 311d extending in the first direction (x) and the second direction (y) may be equal to that of the first electrode active material layer 111c. The size of the second conductive layer 312d extending in the first direction (x) and the second direction (y) may be equal to that of the second electrode active material layer 112c.

Each of the first conductive layer 311d and the second conductive layer 312d may include at least one of carbon nanotubes (CNT), carbon black, Denka black, and Super-P.

The first conductive layer 311d and the second conductive layer 312d may increase the bonding strength between the first substrate 111a and the first electrode active material layer 111c and the bonding strength between the second substrate 112a and the second electrode active material layer 112c, respectively.

The secondary battery according to the above-described embodiment can be used to manufacture a battery pack.

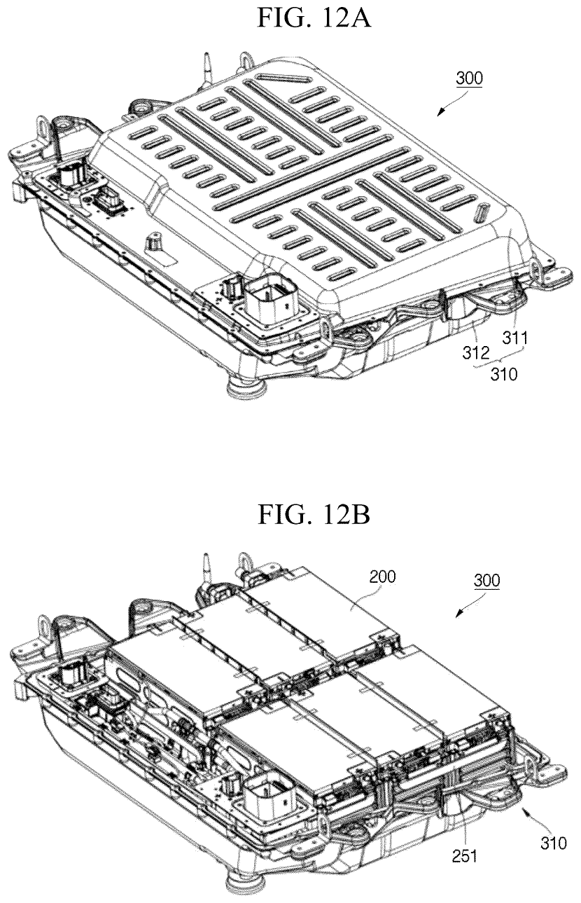

FIGS. 12A and 12B are perspective views showing an exemplary battery pack 300. The battery pack 300 may include a plurality of battery modules 200 and a housing 310 configured to accommodate the plurality of battery modules 200. For example, the housing 310 may include a first housing 311 and a second housing 312, which are coupled to each other in directions facing each other with the plurality of battery modules 200 interposed therebetween. The plurality of battery modules 200 may be electrically connected to each other using bus bars 251. The plurality of battery modules 200 may be electrically connected to each other in series, in parallel, or in a combination thereof, so that desired electrical output may be obtained.

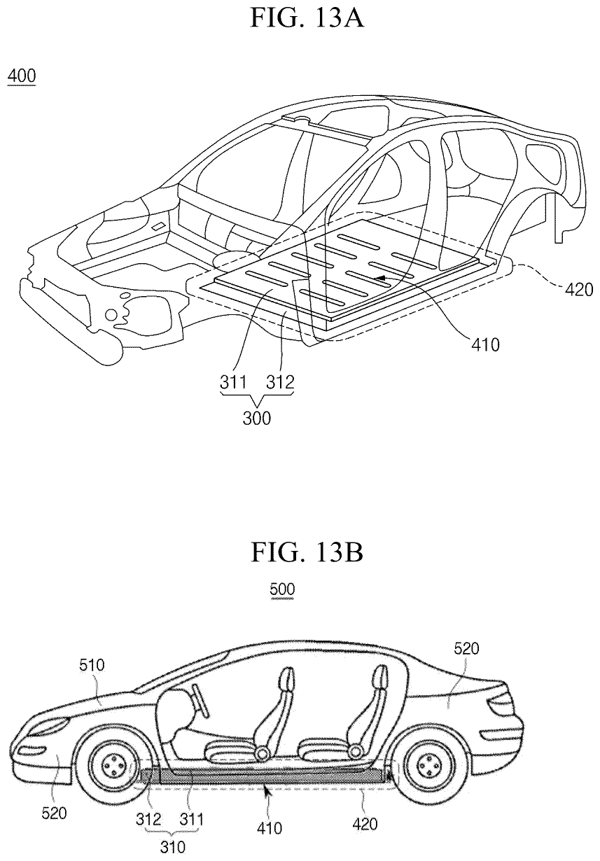

FIGS. 13A and 13B are, respectively, a perspective view showing an exemplary vehicle body 400 and a side view showing an exemplary vehicle 500. As shown in FIG. 13A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 13B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. An electrode assembly comprising:
a first electrode plate;
a separator; and
a second electrode plate, wherein:
the first electrode plate comprises:
a first insulating layer having a first surface and a second surface;
a first substrate configured to cover both the first surface and the second surface of the first insulating layer, the first substrate being made of a metal foil, the first substrate having a first electrode tab, the first electrode tab extending and protruding in a first direction from one side of the first substrate, and the one side of the first substrate extending in a second direction; and
a first electrode active material layer configured to cover at least one surface of the first substrate,
wherein the first electrode tab consists of an uncoated portion that is not coated with the first electrode active material layer.

2. The electrode assembly as claimed in claim 1, wherein the first electrode tab and the first insulating layer do not overlap each other on a plane.

3. The electrode assembly as claimed in claim 1, wherein the first substrate comprises:
a first x substrate having a receiving recess configured to allow the first insulating layer to be received therein; and
a first y substrate configured to cover the first x substrate and the first insulating layer after the first insulating layer is received in the receiving recess.

4. The electrode assembly as claimed in claim 3, wherein:
a width of the receiving recess is equal to a width of the first insulating layer, and
a length of the receiving recess is equal to a length of the first insulating layer.

5. The electrode assembly as claimed in claim 1, wherein the first electrode active material layer overlaps the first insulating layer on a plane.

6. The electrode assembly as claimed in claim 1, wherein the first substrate and the first insulating layer have a same length in the second direction.

7. The electrode assembly as claimed in claim 1, wherein a length of the first substrate in the first direction, excluding the first electrode tab, is equal to or greater than a length of the first insulating layer in the first direction.

8. The electrode assembly as claimed in claim 7, wherein
the first electrode plate further comprises an other side, wherein the other side is opposite the one side, and
the first substrate and the first electrode active material layer are exposed on each of the one side and the other side.

9. The electrode assembly as claimed in claim 7, wherein
the first electrode plate further comprises an other side, wherein the other side is opposite the one side, and
the first substrate, the first electrode active material layer, and the first insulating layer are exposed on each of the one side and the other side.

10. The electrode assembly as claimed in claim 1, wherein the first insulating layer comprises at least one of polyimide (PI), polyethylene terephthalate (PET), polypropylene (PP), polyethylene (PE), polystyrene (PS), acrylonitrile butadiene styrene (ABS), polyoxymethylene (POM), polyvinyl chloride (PVC), polycarbonate (PC), polycaprolactone (PCL), polylactic acid (PLA), acrylic resin, polybutylene terephthalate (PBT), celluloid, polytetrafluoroethylene, Bakelite, epoxy, melamine-formaldehyde, amino, and phenol-formaldehyde.

11. The electrode assembly as claimed in claim 1, further comprising a first conductive layer interposed between the first substrate and the first electrode active material layer.

12. The electrode assembly as claimed in claim 11, wherein the first conductive layer comprises at least one of carbon nanotubes (CNT), carbon black, Denka black, and Super-P.

13. The electrode assembly as claimed in claim 1, further comprising a first protective layer configured to cover a first region of the first electrode tab adjacent to the first electrode active material layer and a second region of the first electrode active material layer adjacent to the first electrode tab.

14. The electrode assembly as claimed in claim 13, wherein the first protective layer is formed by applying at least one of polyimide (PI) or ceramic or by attaching a polyethylene terephthalate (PET) tape.

15. The electrode assembly as claimed in claim 1, wherein
the second electrode plate comprises:
a second insulating layer having a third surface and a fourth surface;
a second substrate configured to cover both the third surface and the fourth surface of the second insulating layer,
the second substrate being made of a metal foil,
the second substrate having a second electrode tab, the second electrode tab extending and protruding in the first direction from a first side of the second substrate,
the first side of the second substrate extending in the second direction; and
a second electrode active material layer configured to cover at least one surface of the second substrate,
wherein the second electrode tab consists of an uncoated portion that is not coated with the second electrode active material layer.

16. The electrode assembly as claimed in claim 15, wherein the first electrode tab and the second electrode tab overlap each other in a third direction (z), which is a height direction, wherein the first electrode plate and the second electrode plate are stacked in a state in which the separator is interposed therebetween.

17. The electrode assembly as claimed in claim 16, wherein the first electrode tab and the second electrode tab are spaced apart from each other in the second direction such that the first electrode tab and the second electrode tab are electrically separated.

18. The electrode assembly as claimed in claim 15, wherein the second electrode tab and the second insulating layer do not overlap each other on a plane.

19. The electrode assembly as claimed in claim 15, further comprising a second conductive layer interposed between the second substrate and the second electrode active material layer.

20. A secondary battery comprising:
the electrode assembly as claimed in claim 1; and
a case configured to receive the electrode assembly therein.
